(19) United States
(12) Patent Application Publication
(10) Pub. No.: US 2010/0030641 A1
(43) Pub. Date: Feb. 4, 2010

(54) SYSTEM FOR TARGETED ADVERTISING

(75) Inventor: Nicolas IBENFORTH, Helsingor (DK)

Correspondence Address: SUGHRUE MION, PLLC, 2100 PENNSYLVANIA AVENUE, N.W., SUITE 800, WASHINGTON, DC, 20037, US

(73) Assignee: Eovendo ApS, Brabrand (DK)

(21) Appl. No.: 12/182,529

(22) Filed: Jul. 30, 2008

(51) Int. Cl. G06Q 30/00

(52) U.S. Cl. 705/14.49

(57) ABSTRACT

A system for targeted advertising. The system comprises a client computing device having Internet connectivity and at least one display screen, a browser software adapted to run on said client computing device for accessing World Wide Web content, an advertising software adapted to run on said client computing device, said advertising software allowing the user to indicate preferred categories of advertisements. The advertising software comprises means for downloading multimedia files comprising moving image advertisements in according with said preferred categories and the advertising software is adapted to display said multimedia files as moving image advertisements on the screen. When running, the advertising software is adapted to at least temporarily block access to World Wide Web content.

### FIELD OF THE INVENTION

The present invention relates to a system for targeted advertising using computers connected to the Internet, in particular adverts with moving images.

### BACKGROUND OF THE INVENTION

In advertising products and services, advertisers have always had an interest in targeted advertising, that is to say finding a way of getting the advertising message to those who are actually potential costumers, and not wasting effort and resources on those who have no need for or interest in the products or services. With the advent personal computers connected to the Internet, and people retrieving information via the World Wide Web, such targeted advertising has become increasingly possible as compared to traditional broadcast media, public posters, etc. In addition to this, and perhaps more even more important, it has become possible to track to some degree, who actually takes an interest in the advertising message.

Apart from that, different types of adverts have different value in general. That is to say the advertising value of a small printed advertisement is far less than e.g. a 30 second moving image advertisement. This is also reflected in the effort put into the production of moving image advertisements, some of which are both well directed and entertaining to a degree, where viewers take a pleasure in watching them.

Now, when adverts are properly targeted to the user, their value increase even further, because fewer resources are wasted on non-potential costumers. Taking this one step further means that if a potential costumer by indicating his specific interest in certain products or services, it may even be worthwhile for the advertiser to pay the costumer to watch the adverts.

If the user is to have a proper economical benefit from watching the adverts, the adverts will have to be the ones with the highest value, i.e. moving image advertisements, e.g. of a duration of 30 seconds as indicated above.

In US 2000/0032906 it is suggested to remunerate the viewer for watching moving image advertisements.

However simply remunerating the consumer to watch the advertisements is not necessarily sufficient to gain his acceptance. In fact, watching adverts is only interesting for the consumer if the remuneration he receives is in a reasonable relationship the effort he has to put into it. That is to say that the consumer should not have to invest much effort in installing the parts of the system, i.e. the programs, he needs on his computer, he should not have to deal with complicated procedures when starting and running the program, he should not be facing any annoying delays, where he might feel that he wastes his time. The consumer should have an easy way of accessing the program falling naturally into his normal routines when he uses his computer.

On the other hand, if the advertiser is to remunerate the consumer for watching the advertisements, he has to make certain that the consumer actually watches the advertisements. Thus, some kind of user activity for verification is needed in order to verify that the advertisement has actually been watched.

### BRIEF SUMMARY OF THE INVENTION

The present invention provides a system for targeted advertising, said system comprising a client computing device having Internet connectivity and at least one display screen, a browser software adapted to run on said client computing device for accessing World Wide Web content, an advertising software adapted to run on said client computing device, said advertising software allowing the user to indicate preferred categories of advertisements, said advertising software comprising means for downloading multimedia files comprising moving image advertisements in according with said preferred categories, said advertising software being adapted to display said multimedia files as moving image advertisements on the screen, wherein said advertising software is adapted to at least temporarily block access to World Wide Web content as long as it is running. Subsequently the user is then automatically directed to the World Wide Web.

### BRIEF DESCRIPTION OF THE SEVERAL VIEWS OF THE DRAWING

Examples of the invention will now be explained below with reference to the very schematic drawings, in which:

FIG. 1 depicts client computers connected to a server via the Internet.

FIG. 2 is a flowchart illustrating the operation of the program during normal use.

FIG. 3 diagram illustrating the workflow of registration in a simplified manner.

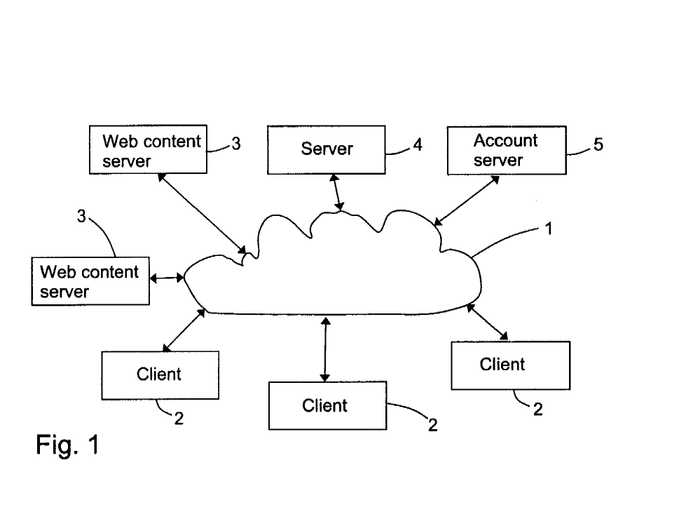

In FIG. 1 a number of computers are interconnected via the Internet 1 so as to allow them to communicate with each others. The details of this is well known for the person skilled in the art and will not be dealt with. Via the Internet a number of client computers 2, such as personal computers used at home or at work may connect access World Wide Web content from a number of computers operating as web content servers 3 for providing web content, such as news, shopping services, etc. It should, however, be noted that the invention is not restricted to general purpose personal computers, rather any computing device with multimedia capability and sufficient Internet connectivity, such as a gaming console, a personal digital assistant or a cellular phone may constitute the client computer 2.

Typically the user of the client computer 2 uses a client program such as a browser running on the computer 2 for accessing this web content. For administrating the targeted advertising according to the present invention a server 4 is also connected to the Internet 1. For administrating the remunerations involved in the present a third party account server 5 may also be connected to the Internet 1.

The general idea of the present invention is to prevent access from a client computer 2 to the web content servers until the user of the client computer has watched a number of advertisements for which he is remunerated, or decided that he does wish to be remunerated and actively decides not to watch the advertisements. It should in this respect in particular be noted that it is not the intention to restrict the user's access to the Internet as such. Such a restriction, which would prevent the user from checking his email, updating his antivirus patterns, his operating system etc. would hardly find acceptance among users in general.

For this, a program, in the following referred to as the advertising software, is installed on the client computer 2. The advertising software may be a separate program via which the user launches his browser or it may be a plug-in which automatically starts up when he launches his browser or it may even be an integrated part of a specifically adapted browser.

The advertising software comprises means for user to indicate preferred categories of advertisements. Information about these preferred categories may be stored locally on the client computer 2 and/or externally on a server, e.g. the server 4. The advertising software further comprises means for downloading multimedia files, in particular moving image advertisements in according with the preferred categories. This download may be provided directly from a central sever, e.g. the server 4 or it may, as is presently preferred, be downloaded from distributed locations. The advertising software is also adapted to display said multimedia files as moving image advertisements on the screen, so as to allow the user to watch them. In principle the multimedia files may be in any appropriate format, it is however currently preferred to use MPEG-4 encoded files, such as H.264 encoded files, or Flash Video files (.flv).

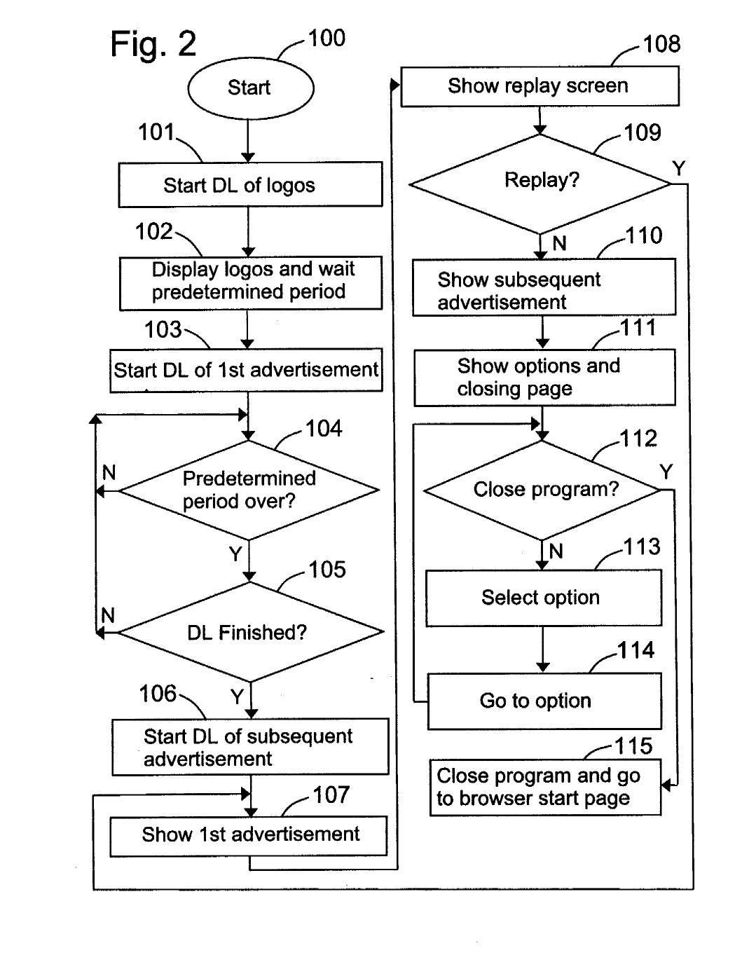

In FIG. 2, the general operation of the advertising software, when installed on a computer 2, is illustrated. That is to say that initial download of the advertising software and installation thereof on the computer 2 has already been made, and that in that connection the selection of preferences such as preferred categories for advertisements and the designation of an account for receiving remuneration has already been made.

The execution of the advertising software starts in 100 by user action, e.g. by the user clicking on an icon displayed on a graphical user interface on his computer display.

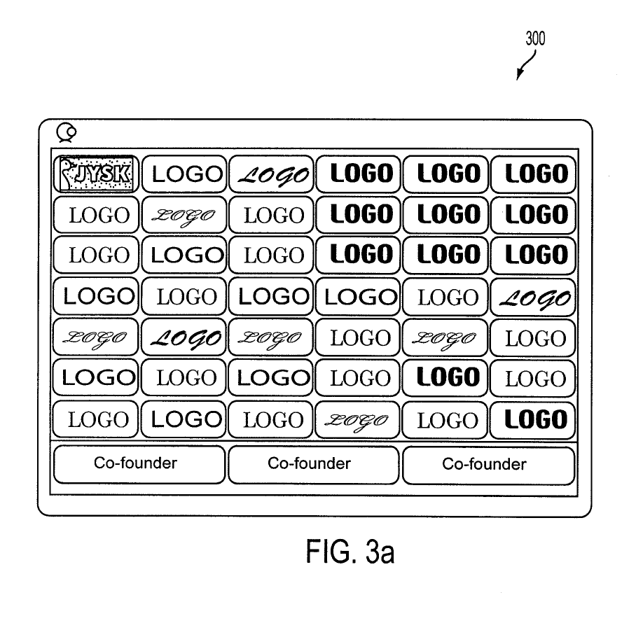

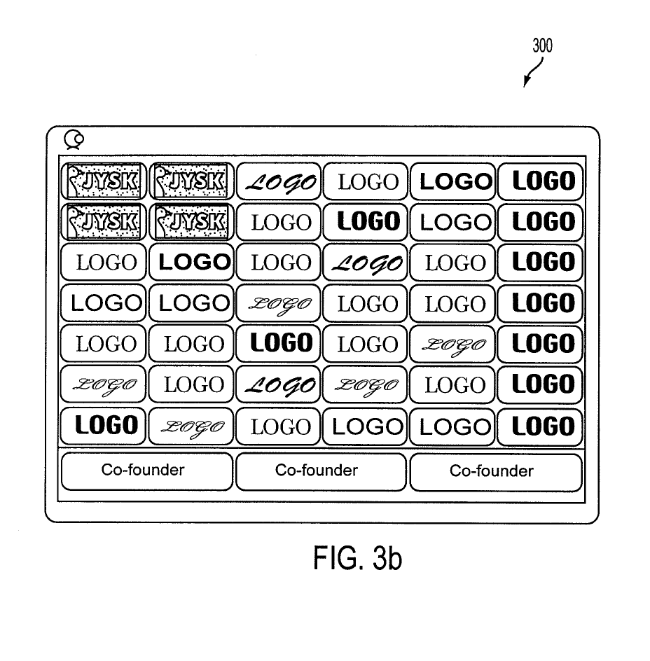

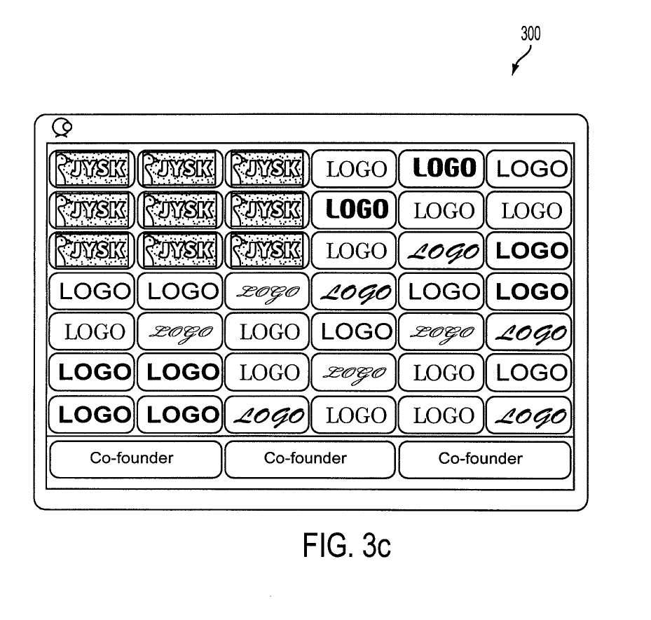

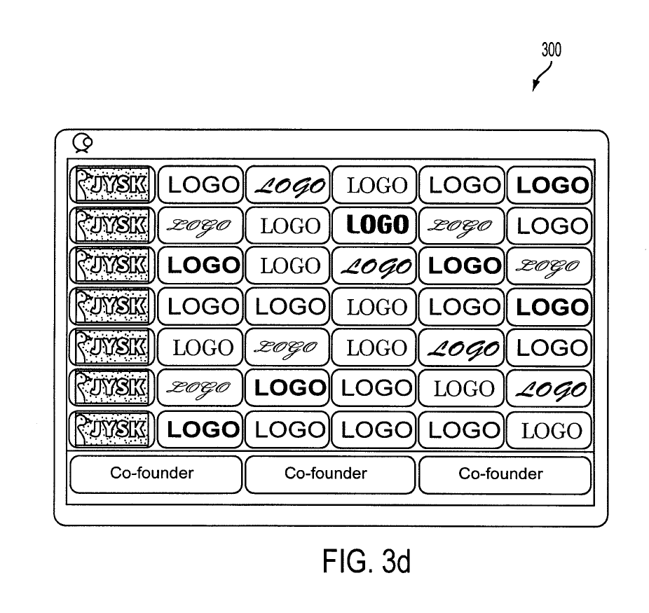

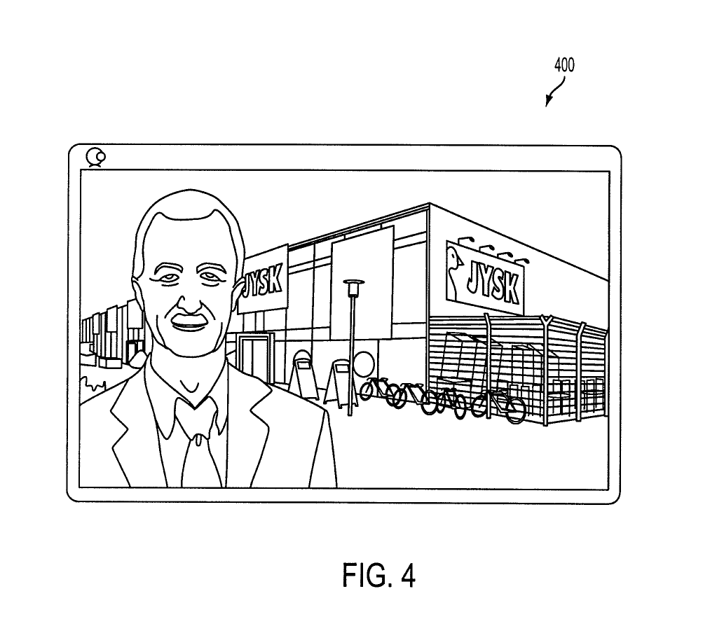

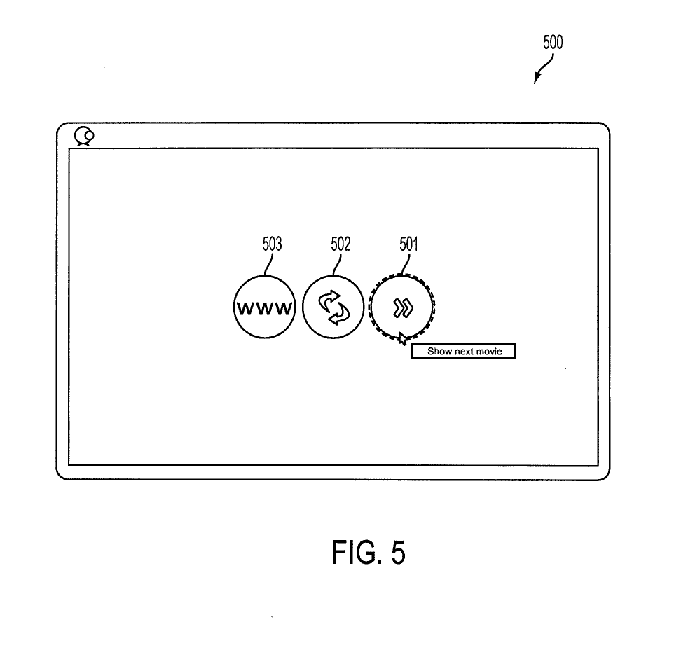

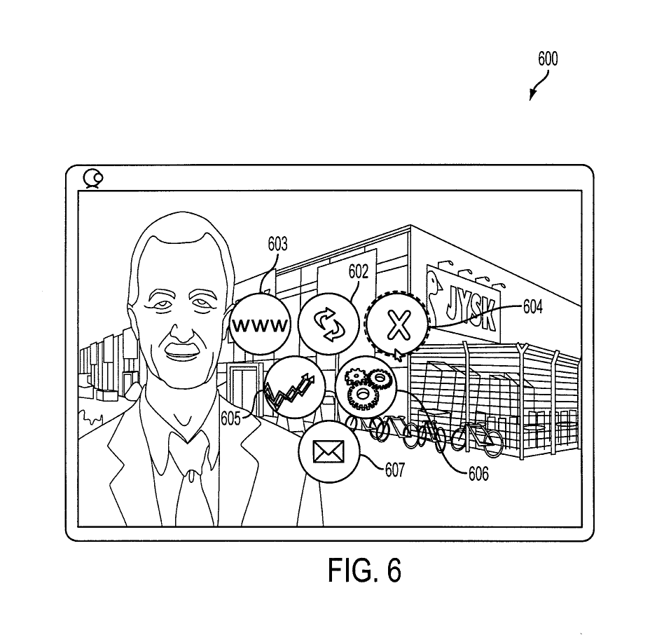

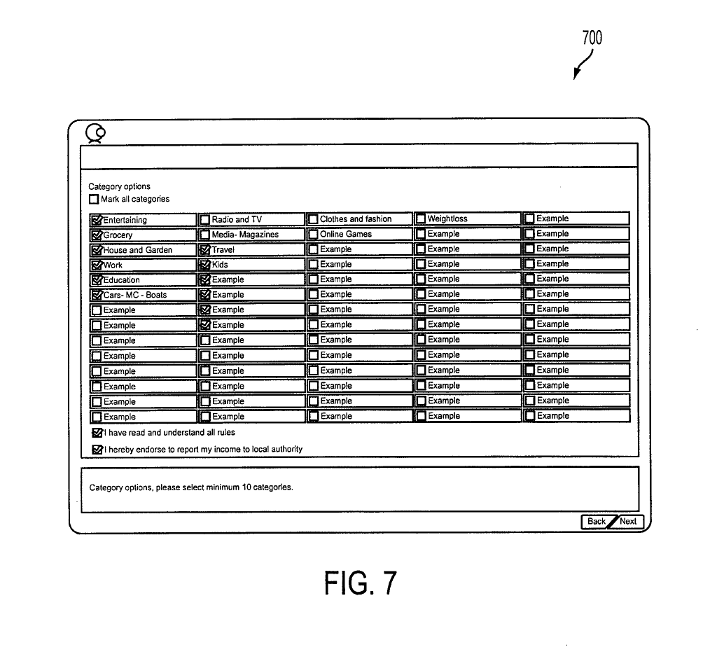

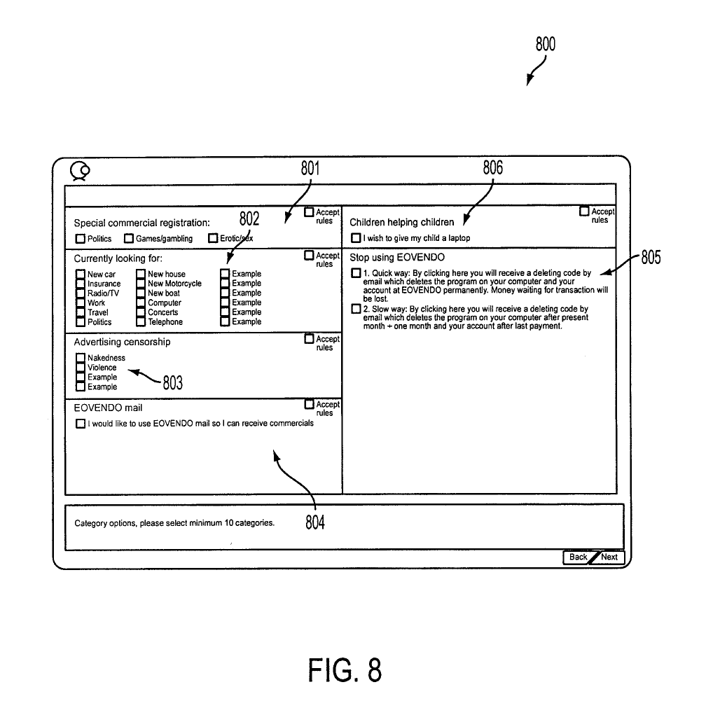

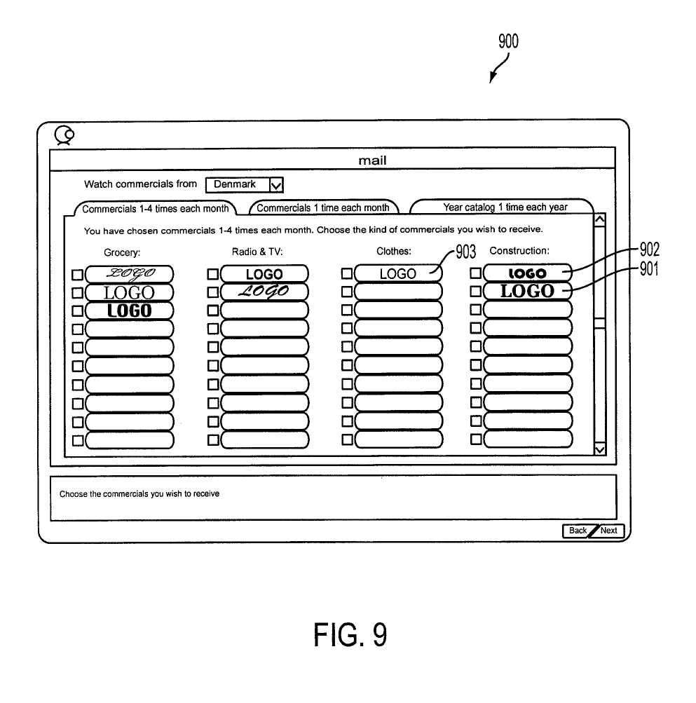

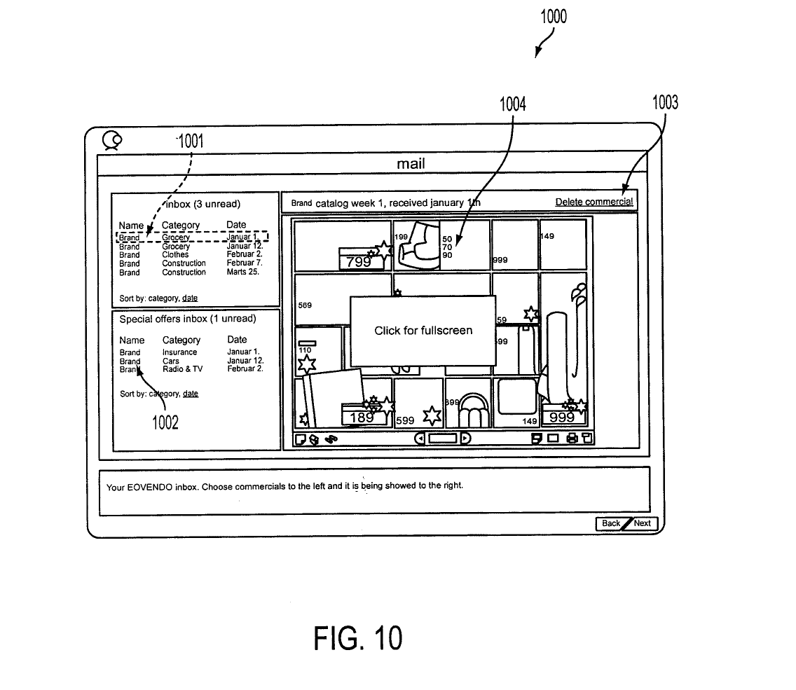

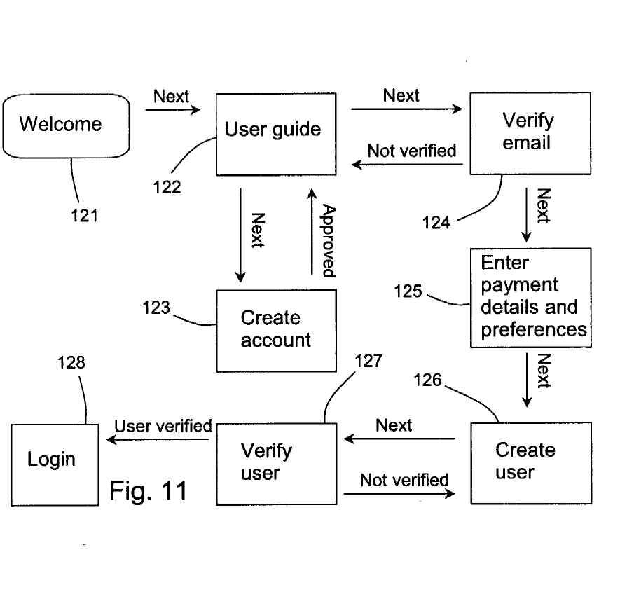

This launches the program, which in box 101 starts downloading a number of brand logos to be displayed as a number of still adverts on an opening screen 300 in box 102, as illustrated in FIGS. 3a-3d. Preferably, in box 102, the opening screen 300 is not displayed until all logos have been downloaded, in order not to give the user an impression of waiting. FIGS. 3a-3d illustrate that one advertiser may pay for several logos on the same screen and have them grouped together in various ways for maximum effect. Meanwhile, an optional splash screen with information about the advertising software could be presented in order to reassure the user that the software has been properly launched. However, in order to allow acceptable download times for the moving image adverts the software is intended to be used with high speed Internet connections only, and the download time for the logos is usually negligible. A splash screen is thus only an option, which could be dispensed with.

The download time for multimedia such as a 30 second high resolution moving image advertisement is however not negligible. Thus immediately after the start of the display of the logos in box 102 on preferably immediately after the download thereof, the advertising software proceeds to box 103 and starts downloading the first moving image advertisement to be shown. Apart from the advertising value, the main purpose of the display of the logos in box 102 is to occupy the attention of the user during the download time for the first moving image advert. Thus in decision box 104 it is checked whether a predetermined display period for the opening screen has expired. With the current speed of Internet connections it has been found that displaying the opening screen for 9 seconds suffices to buffer enough of the moving image advertisement to allow it to play uninterrupted for a 30 second duration. If the Internet connection speed is known or turns out to be insufficient for the moving image advertisement to play uninterrupted for the duration, it may be necessary to buffer more of it or even download the moving image advertisement in its entirety. In this case, it is in an optional step, box 105, checked whether a sufficient part, e.g. as illustrated the entire moving image advertisement, has been downloaded, before proceeding to display the moving image advertisement in box 107. See also FIG. 4 as an example of a display screen 400 displaying a moving image advertisement. After the entire first moving image advertisement has been downloaded, the download of the subsequent moving image advertisement starts. In the illustrated example where an entire moving image advertisement is buffered before display, this subsequent download starts in box 106 immediately before (as illustrated) or at virtually the same time as the display starts in box 107, thus allowing the subsequent moving image advertisement to be downloaded during the display of the first moving image advert. The skilled person will however understand that the download of the subsequent moving image advertisement may start at any time after the completion of the download of the first moving image advertisement, i.e. even if that one is still being displayed.

The moving image adverts, i.e. the multimedia files, may be downloaded from a central server, e.g. the server 4 to each of the clients 2. It is however preferred that the multimedia are to a large extent distributed directly between the users. Preferably this is done using a peer-to-peer technology such as BitTorrent, where the server 4 initially supplies the multimedia files, and subsequently keeps track of which clients computers 2 stores which files, allowing them to be distributed directly between the client computers 2. Using BitTorrent technology furthermore allows different parts of a multimedia file to be supplied from different uploading client computers 2 to the downloading client computer 2. Hence, different pieces of the same file may be downloaded from various available sources, i.e. client computers 2, thus distributing the load on the Internet and relieving the load on the server 4.

Moreover the use of BitTorrent technology could obviate the need for a central server 4 for storing the files initially. Instead the providers of the moving image advertisement could themselves distribute the films initially, uploading only tracking information to the server 4.

To further decrease the load on the server 4, it is envisaged that some users of client computers 2 could be remunerated for storing the entire multimedia files for an extended time period for the distribution to others.

After the first moving image advertisement has been displayed a replay screen 500 as illustrated in FIG. 5 is displayed in box 108. The replay screen allows the user the choice in box 109 between watching the moving image advertisement again for pleasure—preferably not for additional remuneration, or watching the subsequent moving image advertisement for remuneration in box 110. The main purpose of the replay screen is however not the choice. Rather, the replay screen is presented in order to prompt a user feedback input from the user, thus verifying that he has actually watched the moving image advertisement. Preferably, the choice between replay or subsequent moving image advertisement should take place within a predetermined time after the screen has been displayed, i.e. to ensure that the user actually stayed in place in front of the screen during the display of the moving image advertisement. A duration of this predetermined time of less than 10 seconds is currently preferred. This increases the likelihood that he actually did watch the moving image advertisement for which he is remunerated, but evidently this can never be guaranteed. In this respect it should also be noted that the software is designed to always run in the foreground of a multitasking desktop environment. In this way it is ensured that the user does not simply minimize the window in which the software is running or brings op another program in front of it during the display of the moving image advertisements.

For the use feedback input a number of buttons are provided on the replay screen as illustrated in FIG. 5. Here, pressing the button 501 will initiate the display of the next moving image advertisement, i.e. proceeding to box 110, whereas pressing button 502 will initiate a replay of the last moving image advertisement displayed, i.e. returning to box 107. Moreover pressing the button will send information that the moving image advertisement has been watched back to the server 4. The server 4 registers the watching and makes the necessary provisions for crediting the user's account. In this respect it should be noted that in order to limit the amount of remuneration obtainable the number of installations of the advertising software on a single computer is preferably limited to one. An installation for each user could however be envisaged in a multiuser environment. Also, the server keeps track of the number of moving image advertisements displayed, and restricts the overall number of moving image advertisements displayable. In this respect it is currently preferred to limit the number of displayable moving image advertisements to three in a two hour time period. If this number is reached and the time period has not expired, the server 4 communicates this to the advertising software, which then automatically ends and starts the user's browser, i.e. goes to box 115.

As illustrated by the button 503 the user may also be given other options, e.g. downloading in the background an advertisement page relating to the moving image advertisement just watched, e.g. for further information or purchase. Though less preferred there could as an alternative or in addition to this be an option of quitting the advertising software and go directly to the World Wide Web without display of any further moving image adverts, i.e. going to box 115.

The steps of boxes 106 to 110 may be repeated as often as desired without deviating from the scope of invention. It is however currently preferred to repeat only once, the number of moving image advertisements displayed and watched by the user thus totaling three, before reaching, in box 111, a closing and options screen illustrated in FIG. 6.

Like the replay screen 500, the closing and options screen 600 is presented in order to prompt a user feedback input from the user, thus verifying that he has actually watched the moving image advertisement. Buttons 602 and 603 would correspond to buttons 502 and 503 of FIG. 5, respectively. However, because the closing and options screen 600 is the last screen to be displayed, it involves a larger number of buttons. Thus a closing button 604 is provided. If this button is pressed the execution of the advertising software proceeds to box 115, upon which the advertising software allows the access to the World Wide Web, e.g. by starting the user's browser and closing itself.

A button 605 is provided for allowing the user to see the statistics of his use of the software, in particular the remuneration received. A button 606 is provided for entering the setup allowing the user to change his preferences if they have changed. As an example, if a user has an interest in advertisements relating to automobiles because he wants to buy a new one, this interest is likely to drop just after he has actually bought one.

Pressing one of these buttons represents selection of an option in box 113 of FIG. 2, upon which, in box 114, the software proceeds to the software parts relating to the specific option.

These options are not all of relevance for the present invention and numerous other options can be thought of. These options will not all be dealt with here. However, pressing button 606 will send the user through a number of selection and options pages illustrated in FIGS. 7 and 8. These pages essentially correspond to pages, which the user will also have to go through in his initial installation and registering of the advertising software. Thus, FIG. 7 illustrates a selection screen where an number of different categories of advertisements is listen and the user is required to select a number of them, so as to ensure targeted advertising. It is currently preferred that the user should select at least ten categories, but different numbers could apply, depending on the number of available categories are the degree to which they are detailed. FIG. 8 illustrates a further selection screen 800. This selection screen 800 is subdivides into several groups. The group 801 comprises selections relating to sensitive material such as erotics, gambling, alcoholic beverages etc. where the user has to have a certain age and where his explicit consent to watch the advertisements is desired. The group 802 represents categories where the user has an increased interest in the products, because he is actively interested in them, e.g. looking for an new car or real estate. The group 803 again relates to sensitive material, where the user has to actively give his consent in order to protect users in general from advertisements, which might offend them, such as advertisements depicting nakedness or violence. The field 804 allows the user to sign in to receive advertising brochures in electronic form in a specific mailbox. Signing in to use the mailbox will activate the mailbox option accessible via the button 607 in FIG. 6, as will be described further below. The field 805 allow the user to stop using the advertising software and settling his account in various ways.

Field 806 represents a further inventive aspect of the invention, helping children around the world and aiding in the proliferation of the advertising software. If the user ticks this box, he may indicate the wish to donate a computer to a child, be it his own offspring or a needing child in the neighborhood or at a local school. This option is only available for loyal users who have used the advertising software on a regular basis for an extended period of time. The computer will be supplied to the desired child with the advertising software preinstalled in a locked manner, allowing access to the Internet via the advertising software only. Various different schemes for financing the computer may be envisaged. The currently preferred way would allow the provider of the advertising software to donate the computer, and thus gaining a further user. Another way would allow the donator to pay for the computer using his earned remuneration. A third way would allow the computer manufacturer to donate the computer, e.g. against free advertising time using the advertising software.

Returning now to the mailbox option. As briefly indicated above, the advertising software has an integrated advertising mailbox for receiving advertising brochures. In the country of the inventor many retailers distribute printed brochures to people's physical mailboxes on a weekly, bi-weekly or monthly basis in order to inform about special offers to attract costumers. Very many of these retailers also publish electronic versions of the printed brochures on the Internet, and some even allow people to subscribe to email delivery of them.

By using the mailbox option of the advertising software the user would automatically receive electronic versions of the brochures from various retailers, depending on his selection. Thus he would not need to actively look for them at the retailers Internet site, risk to overlook them in his email inbox, or overlook the printed brochure in his physical mailbox. These electronic brochures would then automatically be downloaded and updated in the background while the user is watching the last moving image advertisement. FIG. 9 show as selection 900 screen allowing the user to select adverts from various retailers by clicking appropriate buttons 901, 902.

FIG. 10 shows the in-box screen 1000. At the left-hand side of the screen the brochures, which have been downloaded to the mailbox, are listed. As shown, the mailbox screen 1000 comprises there are two different in-boxes, one in-box 1001 for the regular, e.g. weekly, brochures and one in-box 1002 for extra issues, such as special offer or campaign issues. The user may select any brochure listed and it is then displayed in a window 1004 on the right-hand side of the screen. As indicated the mailbox may comprise a full screen display mode so as to allow the user to better read the brochure. The in-box screen further has means 1003 for the user to delete a selected brochure, e.g. after having read it. Older brochures may of course also be deleted automatically by the advertising software.

Having described the general operation of the advertising software, an example of download and initialization will now be described, with reference to FIG. 11. Before the user can use the advertising software for the first time an initialization process must be carried out in order to secure the necessary data about the user, such as an account for payment, contact details, preferences with regard to advertising etc. Some or most of this initialization may take part before the user is allowed to download the advertising software in the first instance. Alternatively it may form a part of the process of installing the software after download thereof or it may be carried out during first run of the installed advertising software. The example of FIG. 11 illustrates the latter. Starting up the advertising software for the first time the user receives a welcoming message in box 121. He is then directed to a user guide in box 122. In the user guide he is prompted to create an account if he does not already have one. This account, which is created, in box 123, is preferably an account provided by third party such as PayPal™ rather than account set up by the provider of the advertisement software. When the user has created an account the submits an email address as his unique identification. The email address is verified in box 124, e.g. by sending the user an access code via the submitted email. If the email cannot be verified the process returns to box 123, where the user is prompted to resubmit it (or another valid one). When the user has submitted a valid email address, this will allow him to enter the necessary details, in box 125, such as payment details, and preferences for advertisement messages. The user is then created locally in box 126 and the relevant details sent to the server 4 so that the user can be verified in box 127 for this and future sessions. If the user is verified an automatic login is performed in box 128 and the normal operation of the advertising software as described above with reference to FIG. 2 starts.

The above description was given based on preferred exemplary embodiment of the invention, and should not be considered limiting the scope of the invention. The skilled person will realize that numerous variations and modifications of the examples are possible without deviating from the scope of invention as set out in the appended claims.

1. A system for targeted advertising, said system comprising
a client computing device having Internet connectivity and at least one display screen,
a browser software adapted to run on said client computing device for accessing World Wide Web content,
an advertising software adapted to run on said client computing device,
said advertising software allowing the user to indicate preferred categories of advertisements,
said advertising software comprising means for downloading multimedia files comprising moving image advertisements in according with said preferred categories,
said advertising software being adapted to display said multimedia files as moving image advertisements on the screen, wherein
said advertising software is adapted to at least temporarily block access to World Wide Web content as long as it is running.

2. A system according to claim 1, wherein said advertising software is adapted to block access to said browser software.

3. A system according to claim 1, wherein advertising software is adapted to upload the downloaded multimedia files to other client computing devices.

4. A system according to claim 3, wherein said software comprises means for registering information about the upload of multimedia files, means for communicating said information to a server, said server comprising means for effecting remuneration of a person identified as the user of the software.

5. A system according to claim 1, wherein said browser software further comprises a mailbox adapted for receiving and displaying electronic advertisement brochures.

6. A system according to claim 1, wherein a number of still image adverts are downloaded and subsequently displayed during the download of the first moving image advertisement to be displayed.

7. A system according to claim 6, wherein said none of the still image adverts are displayed until all the still image adverts have been downloaded.

8. A system according to claim 1, wherein said advertising software displays said multimedia files as moving image advertisements on the screen in a temporal sequence, the displaying of the next moving image advertisement being contingent to user input action within a certain time limit after the preceding moving image advertisement is finished.

9. A system according to claim 1, having means for allowing only a predetermined number of moving image advertisements may to be displayed within a given time period.

10. A system according to claim 1, wherein said software comprises means for registering information about the display of said moving image adverts, means for communicating said information to a server, said server comprising means for effecting remuneration of a person identified as the user of the software.

11. A system according to claim 1, wherein the computing device is selected from the group of a personal computer, a gaming console, a personal digital assistant, a cellular phone.

12. A system for targeted advertising, said system comprising
a client computing device having Internet connectivity and at least one display screen and a preloaded advertising software,
a browser software adapted to run on said client computing device for accessing World Wide Web content, wherein
said advertising software adapted to run on said client computing device,
said advertising software allowing the user to indicate preferred categories of advertisements,
said advertising software comprising means for downloading multimedia files comprising moving image advertisements in according with said preferred categories,
said advertising software being adapted to display said multimedia files as moving image advertisements on the screen, wherein
said advertising software is adapted to at least temporarily block access to World Wide Web content as long as it is running.
